(19) United States
(12) Patent Application Publication
(10) Pub. No.: US 2008/0134730 A1
(43) Pub. Date: Jun. 12, 2008

(54) COMBINATION LOCK

(75) Inventor: Thomas Becker, Hunfelden-Heringen (DE)

Correspondence Address: GIFFORD, KRASS, SPRINKLE,ANDERSON & CITKOWSKI, P.C, PO BOX 7021, TROY, MI, 48007-7021, US

(73) Assignee: ABUS August Bremicker Sohne KG, Wetter-Volmarstein (DE)

(21) Appl. No.: 11/950,507

(22) Filed: Dec. 5, 2007

(30) Foreign Application Priority Data
Dec. 7, 2006 (DE) 10 2006 057 759.0

(51) Int. Cl. E05B 37/00; E05B 67/00

(52) U.S. Cl. 70/30

(57) ABSTRACT

The invention relates to a combination lock, in particular for two-wheelers, having a lock body and a bolt which are permanently connected to one another via a flexible connection device—such as a cable, a spiral cable, an armored cable, a chain or the like—, wherein the lock body has a combination locking mechanism, wherein the bolt has a bolt body and a bolt mandrel with a plurality of lateral engagement cut-outs, and wherein the bolt mandrel can be introduced into the lock body to cooperate there with the combination locking mechanism. The bolt mandrel is made as a sheet metal part which is made separately from the bolt body and is permanently fastened to the bolt body.

### CROSS-REFERENCE TO RELATED APPLICATIONS

This application claims priority of German Patent Application No. 10 2006 057 759.0 filed Dec. 7, 2006.

### FIELD OF THE INVENTION

The invention relates to a combination lock, in particular for two-wheelers, having a lock body and a bolt which are permanently connected to one another via a flexible connection device—such as a cable, a spiral cable, an armored cable, a chain or the like—, wherein the lock body has a combination locking mechanism, wherein the bolt has a bolt body and a bolt mandrel with a plurality of lateral engagement cut-outs, and wherein the bolt mandrel can be introduced into the lock body to cooperate there with the combination locking mechanism.

### BACKGROUND OF THE INVENTION

Combination locks in which the bolt and the lock body are each made from cast material, for example from zinc die cast material, are generally known. The bolt mandrel is made as a cylindrical spigot in the known combination locks at which a comb is formed which has the engagement cut-outs. However, the security against being broken open of such combination locks is limited.

### SUMMARY OF THE INVENTION

It is the underlying object of the invention to provide a combination lock of the initially named kind which ensures increased security against being broken open and in particular a high breaking load capacity.

This object is satisfied by a combination lock having the features of claim 1, and in particular in that the bolt mandrel is made as a sheet metal part which is formed separately from the bolt body and which is permanently fastened to the bolt body.

In accordance with the invention, the bolt mandrel is therefore not made integral with the bolt body as a cast part or injected molded part, but rather as a separate sheet metal part. In this connection, a sheet metal part is to be understood as a flat, rolled metal part. The sheet metal part can have a rectangular cross-section in a plane normal to the longitudinal axis of the bolt mandrel. For example, the sheet metal part can have an aspect ratio, i.e. a ratio of thickness to height, in cross-section of 1:2 or less, in particular of 1:3 or less, with the height being calculated down to the bases of the engagement cut-outs. The bolt body is preferably made from cast material or injection molded material.

The bolt mandrel made from sheet metal has increased security against being broken open with respect to a bolt mandrel made from cast material since a sheet metal part has a higher breaking load capacity than a cast part. This can in particular be due to the higher ductility of sheet metal with respect to cast material. Sheet metal is slightly plastically deformable under the effect of external forces, in particular on an attempted breaking open, with a break not occurring, however, even at a high load or a break only occurring at a particularly high load. It is particularly preferable for the bolt mandrel to be made as a sheet steel part since sheet steel has a particularly high ductility.

Furthermore, a receiving sleeve of the lock body in which the bolt mandrel is received in an introduced position is made more solidly and thus in a more stable manner than in known combination locks having a bolt mandrel substantially round in cross-section since less space is taken up by a narrow sheet metal part than for the reception of a solid cylindrical spigot made of cast material. Since the receiving sleeve is likewise loaded on an attempted breaking open, the security against being broken open can be further increased hereby.

Furthermore, a bolt mandrel made as a sheet metal part is also easier to produce and can be connected to the bolt body with less effort.

Advantageous embodiments of the invention are also set forth in the dependent claims, in the description and in the drawings.

In accordance with an embodiment of the invention, the bolt mandrel has a profile in the longitudinal direction. A particularly high bending stiffness can hereby be achieved so that the security against being broken open is further increased. The profiled section can in particular be such that the bolt mandrel is made substantially in V shape viewed in the longitudinal direction. An S-shaped profile is also possible, for example.

The bolt mandrel or the sheet metal part is made, for example, as a stamped sheet metal part, i.e. manufactured by stamping out. The engagement cut-outs of the bold mandrel can thereby be manufactured at the same time in an advantageously simple manner.

The bolt mandrel preferably has a bore via which the bolt mandrel is fastened, preferably pinned or screwed or riveted, to the bolt body. A particularly simple and simultaneously secure fastening of the bolt mandrel to the bolt body can hereby be ensured. Generally, however, a mutual fixing together or any other squeezing connection is also conceivable. Furthermore, the bolt mandrel can also be guided through a throghgoing slot formed in the bolt body and can be bent over at its end which has been guided through.

In accordance with another aspect of the invention, the lock body includes a receiving sleeve at which a plurality of closing rings of the combination locking mechanism are rotatably supported, with the bolt mandrel being received in the receiving sleeve in a shape matched manner in an introduced position, with an air gap preferably remaining between the bolt mandrel and the receiving sleeve surrounding the bolt mandrel. A particularly stable connection can hereby be achieved between the bolt body and the lock body.

### BRIEF DESCRIPTION OF THE DRAWINGS

A non-restricting embodiment of the invention is represented in the drawing and will be described in the following.

There are shown, schematically in each case:

FIGS. 1a-1d different views of a bolt of a combination lock in accordance with the invention, with a bolt mandrel, and

FIGS. 2a, 2b different views of the bolt mandrel of FIG. 1.

### DETAILED DESCRIPTION OF THE PREFERRED EMBODIMENTS

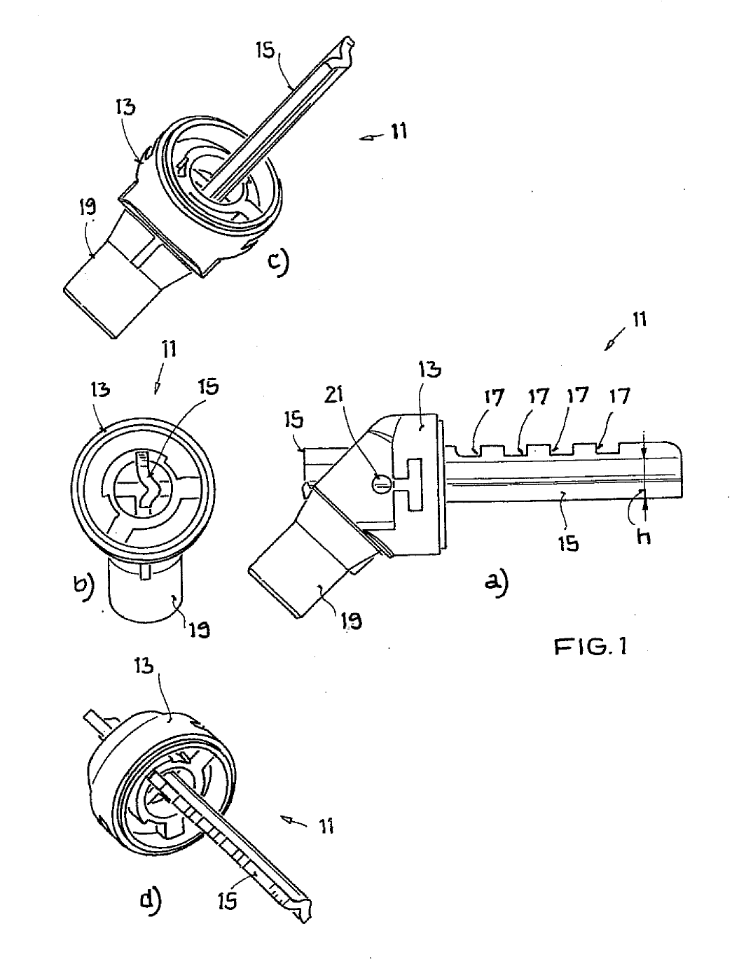

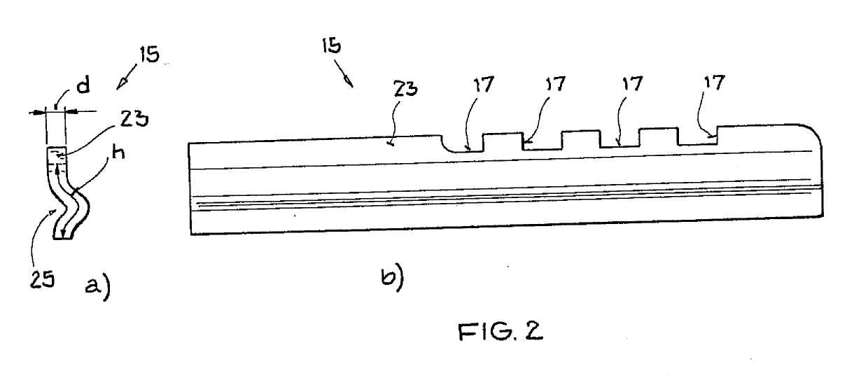

The bolt 11, shown in FIG. 1, of a combination lock in accordance with the invention not otherwise shown includes a bolt body 13 made from a cast material and a bolt mandrel 15 made separately from the bolt body 13, with the bolt mandrel 15 being shown again and in enlarged form in FIG. 2. The bolt mandrel 15 is introduced into a slot made in the bolt body 13 and is secured via a pin 21 which is plugged through a bore extending through the bolt body 13 and the bolt mandrel 15 to fasten the bolt mandrel 15 permanently to the bolt body 13.

The bolt mandrel 15 is made from sheet steel and manufactured by stamping out. The bolt mandrel 15 has a profile in the longitudinal direction while forming a V-shaped recess 25, as can in particular be recognized in FIG. 2a. Furthermore, the bolt mandrel 15 includes an integrally made comb 23 which has a plurality of lateral engagement cut-outs 17. The bolt mandrel 15 without a profiled section or before it is given a profiled section has a rectangular cross-section in a plane normal to its longitudinal axis, said cross-section having an aspect ratio, i.e. a ratio of height h to thickness d, of, for example, 1:3, with the height h being calculated down to the bases of the engagement cut-outs 17.

A lock body having a combination locking mechanism known per se and a flexible connection device, for example a spiral cable, an armored cable or a chain, via which the lock body and the bolt 11 are permanently connected to one another, are not shown in the drawing. The fastening of the flexible connection device to the bolt body 13 takes place via a hollow cylindrical cable mount 19 into which an end of the flexible connection device is first plugged and which is subsequently squeezed.

The lock body includes a receiving sleeve which surrounds the profiled outline of the bolt mandrel 15 in a shape matched manner, with a plurality of closing rings of the combination locking mechanism being rotatably supported at the receiving sleeve. In a latching position, the locking rings engage into the engagement cut-outs 17 of the introduced bolt mandrel 15 such that the bolt 11 is latched to the lock body, whereas in an unlatched position, i.e. with a specific number combination, the closing rings are oriented such that the comb 23 of the bolt mandrel 15 can pass through radial cut-outs formed in the closing rings so that the bolt 11 and the lock body are unlatched, with each closing ring having precisely one radial cut-out.

Overall, the combination lock in accordance with the invention having a bolt mandrel formed from sheet metal ensures increased security against being broken open.

1. A combination lock, in particular for two-wheelers, having a lock body and a bolt (11) which are permanently connected to one another via a flexible connection device—such as a cable, a spiral cable, an armored cable, a chain or the like—, wherein the lock body has a combination locking mechanism, wherein the bolt (11) has a bolt body (13) and a bolt mandrel (15) with a plurality of lateral engagement cut-outs (17), and wherein the bolt mandrel (15) can be introduced into the lock body to cooperate there with the combination locking mechanism,
characterized in that
the bolt mandrel (15) is made as a sheet metal part which is made separately from the bolt body (13) and is permanently fastened to the bolt body (13).

2. A combination lock in accordance with claim 1, characterized in that the bolt mandrel (15) has a profile, in particular has a V-shaped profile, in the longitudinal direction.

3. A combination lock in accordance with claim 2, characterized in that the bolt mandrel (15) is made as a stamped sheet metal part.

4. A combination lock in accordance with claim 1, characterized in that the bolt mandrel (15) is made as a steel sheet part.

5. A combination lock in accordance with claim 1, characterized in that the bolt body (13) is made from a cast material or an injection molded material.

6. A combination lock in accordance with claim 1, characterized in that the bolt mandrel (15) has a bore via which the bolt mandrel (15) is fastened, preferably pinned or screwed or riveted, to the bolt body (13).

7. A combination lock in accordance with claim 1, characterized in that the lock body includes a receiving sleeve at which a plurality of closing rings of the combination locking mechanism are rotatably supported, with the bolt mandrel (15) being received—when it has been introduced into the receiving sleeve—in the receiving sleeve in a shape matched manner.
